(19) United States
(12) Patent Application Publication
(10) Pub. No.: US 2010/0044168 A1
(43) Pub. Date: Feb. 25, 2010

(54) DISC BRAKE IN PARTICULAR FOR COMMERCIAL VEHICLES AND OPERATING CYLINDER FOR A DISC BRAKE

(75) Inventors: Eugen Kloos, Bensheim (DE); Frank Beyer, Mannheim (DE); Andreas Petschke, Heddesheim (DE); Andreas Steinmetz, Gleishorbach (DE); Jürgen Hochlenert, Ladenburg (DE); Michael Häussler, Heidelberg (DE)

Correspondence Address: Schwabe Williamson & Wyatt;PACWEST CENTER, SUITE 1900, 1211 SW FIFTH AVENUE, PORTLAND, OR, 97204, US

(73) Assignee: WABCO RADBREMSEN GMBH, Mannheim (DE)

(21) Appl. No.: 12/374,031

(22) PCT Filed: Jul. 12, 2007
(86) PCT No.: PCT/EP2007/006211

§ 371 Date: Aug. 21, 2009

(30) Foreign Application Priority Data
Jul. 18, 2006 (DE) 10 2006 033 254.7

(51) Int. Cl. F16D 65/18; F16F 9/00

(52) U.S. Cl. 188/73.1; 267/140.13

(57) ABSTRACT

The invention relates to a disc brake, in particular for commercial vehicles, comprising a brake disc (2), a brake caliper (1), a pneumatically acting operating cylinder (3) which has an operating device (8), an applying device (5) which has a rotating lever (7) and a camshaft (6) running parallel to a brake disc plane (6) and at least one brake lining (4). On activating the operating cylinder, the operating device presses the brake lining against the brake disc by means of the rotating lever and the camshaft. According to the invention, a frictional damping device (13, 20) is provided outside the force path of application, which influences the resonant behaviour of the brake.

The invention relates to a disc brake, in particular, for commercial vehicles, comprising

a disc brake,
a brake caliper,
a pneumatically operating actuation cylinder that has an actuation device,
a brake-application device that has a rotating lever and a camshaft extending parallel to a brake disc plane, and
at least one brake pad,

wherein the actuation device presses the brake pad against the brake disc by means of the rotating lever and the camshaft when the actuation cylinder is operated.

Disc brakes of the type referenced in the introduction have been disclosed, for example, in DE 42 30 004 A1, DE 195 10 331 U1, DE 43 07 019 A1, and EP 949 433 A2.

In this regard, additional components/assemblies may be part of the disc brake according to the invention, such as, for example, a pressure piece connected between the camshaft and the brake pad. One or more pressure screws can also be engaged within the described transmission train.

The brake disk rotates relative to the brake pad when the vehicle is in motion. When the brake is not actuated, i.e., when the rotating lever is situated in the rest position, the brake pad should not contact the brake disc. However, due to rough-road travel, imbalances in the brake disc, or excessively-adjusted clearance, what may happen, for example, is that the brake pad (unintentionally) contacts the brake disc. Depending on the rotational speed of the brake disc, such contacts can become evident in the form of multiple pulses or blows in rapid succession. These blows are transferred to the brake caliper, and/or through the camshaft, rotating lever, and actuating device to the actuation cylinder. This can cause the brake to vibrate.

In addition, vibrations can also occur during braking, for example, due to disc runout, imbalance of the disk, or disc or pad washouts. This then results, for example, in rapid oscillations or vibrations, in particular, of the rotating disc. These vibrations are transferred through the actuation device in contact with the rotating lever to the actuation cylinder and/or its individual components.

If the above-described vibrations lie within the resonant range of the brake, a build-up of brake vibrations can occur that, among other things, can result in the development of significant noise. In addition, the vibrations degrade the brake.

The fundamental problem to be solved by the invention is to reduce or eliminate the described effects in a disc brake of the type mentioned in the introduction, in particular, in terms of the development of noise and other impairments of the brake.

According to the invention, the problem posed is solved by a damping device that operates by friction and is located outside the force transmission connection¹ during brake application, this device functioning to modify the vibration behavior of the brake. ¹translator's note: Original text is inconsistent throughout in using two different expressions Kraftschluss (=(frictional) force connection) and Kraftfluss (=force flow) in the same context.

What is meant by the location “outside the frictional force connection during brake application” is that the damping device is situated such that the two elements involved in the friction are not located in tandem within the frictional force connection. In other words, the damping device is located “parallel” to the brake-application force connection. What is achieved thereby is that the brake-application forces do not interfere with the damping device. Secondly, what is achieved is that the damping device does not interfere with brake application, for example, by excessive play or the like. Due to the fact that the damping device is not located within the brake-application force flow, it also does not interfere with the parameter of the brake-application travel. In other words, there is no loss of brake-application travel.

The degree of damping, which essentially is determined by the frictional force generated by the damping device, must be adjusted in each case in accordance with the overall conditions. For example, the frictional force generated by the damping device must thus have a minimum level in order to adequately even affect the vibration behavior so as to be able to dampen or eliminate the above-described resonant vibrations. On the other hand, the frictional force must not be too high in order to allow the brake to be applied and then released (automatically, for example, by an elastic device).

Preferably, provision is made whereby the damping device operates with an indirect or direct frictional connection between two components or assemblies of the brake that are moved relative to each other when the brake is applied.

In other words, in order to apply the frictional force, the damping device utilizes the degrees of freedom of the motion between two selected components or assemblies serving to apply the brake since these degrees of freedom also play a role in terms of the vibrations to be damped.

What is meant by “indirect” or “direct” is that either a component employed in any case for brake application (direct), or also an additional component (indirect) can be used for the damping device.

In another preferred embodiment of the invention, provision is made whereby the damping device produces an indirect or direct (see explanation above) frictional connection between one or more of the following pairs of components or assemblies:

a) brake caliper—pressure screw,
b) brake caliper—axially movable pressure piece or cross member,
c) brake caliper—camshaft,
d) brake caliper—rotating lever,
e) brake caliper—actuation device,
f) actuation cylinder—rotating lever,
g) actuation cylinder—actuation device,
h) actuation cylinder—retracting spring, and
i) camshaft—pressure piece or cross member.

Pairs c) through i) have the advantage that long frictional surfaces (actuation device/rotating lever/camshaft) and/or large motion capabilities (translatory, swiveling, rotating) are available for the damping friction.

Preferably, the damping device has an elastic device that is tensioned, and the elastic restoring force of which acts as the normal force of the frictional connection.

As a result, the frictional force and thus the damping can be adjusted relatively precisely.

An especially simple design results when the damping device has a spring, this approach being preferred according to the invention.

The damping device can in principle have any desired materials. It preferably has metal, rubber, plastic, or a combination thereof.

The damping device furthermore preferably has a wire-shaped and/or a ribbon-shaped component. This further simplifies the design.

In the event a frictional surface has an excessively high or low coefficient of friction in view of the overall conditions, in particular, of the vibration behavior of the brake, according to the invention a coating can preferably be part of the damping device, by which coating the coefficient of friction can be adjusted to a value that is appropriate for damping.

According to the invention, the region of the frictional connection is preferably situated in the path of the relative motion of the two frictional components or assemblies.

In other words, the system ensures that in the event of vibrations that result in a relative displacement of the two components or assemblies that are frictionally interconnected, the frictional connection is not lost even in response to extreme deflections.

In addition, what is in particular preferred according to the invention is that in the installed state the direction of the normal force of the frictional connection of the damping device encompasses an angle of at most 45°, preferably at most 30°, with the horizontal.

In other words, in this embodiment the damping device is situated laterally relative to the component to be damped or assembly to be damped, by which approach the mass or the weight has no effect on the pretension force and thus on the frictional force. As a result, the frictional force and thus the degree of damping can be set precisely.

In addition to the above disc brake as described in detail, the invention also provides an actuation cylinder for such a disc brake.

In particular, the invention provides an actuation cylinder for a disc brake, in particular, for a disc brake of the type described in detail above, comprising a damping device that creates an indirect or direct frictional connection between the actuation cylinder and

a rotating lever,
an actuation device, and/or
a retracting spring.

In other words, the invention also provides an actuation cylinder that is provided with a damping device, wherein the damping device functions to modify the vibration behavior of that brake to which the actuation cylinder is attached.

The following discussion describes the invention in more depth with additional details based on preferred embodiments and with reference to the attached drawing. In the drawing:

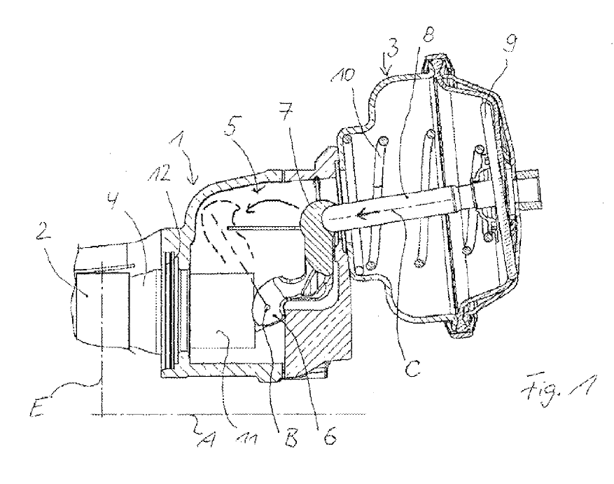

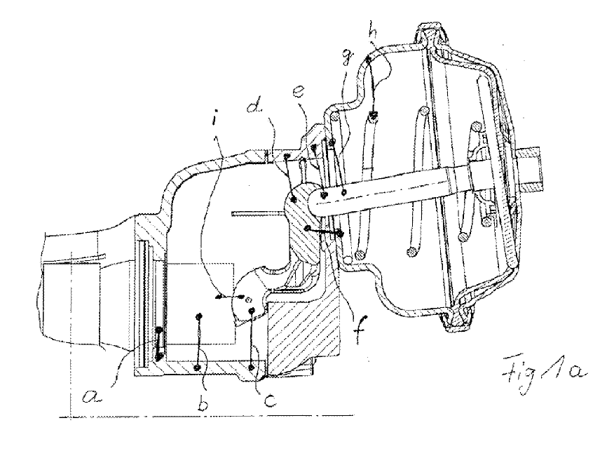

FIG. 1 is a sectional view of a typical disc brake;

FIG. 1a is the same view as FIG. 1, supplemented, however, with schematic references to possible configurations of the damping device;

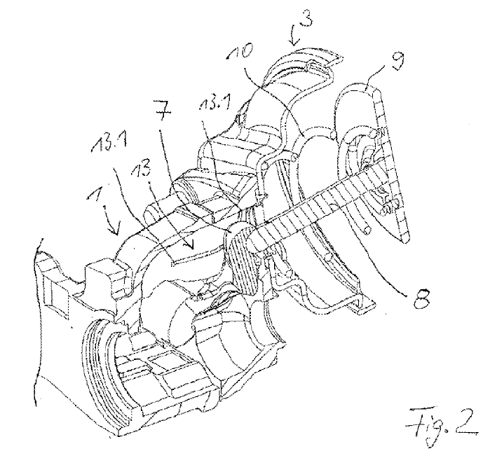

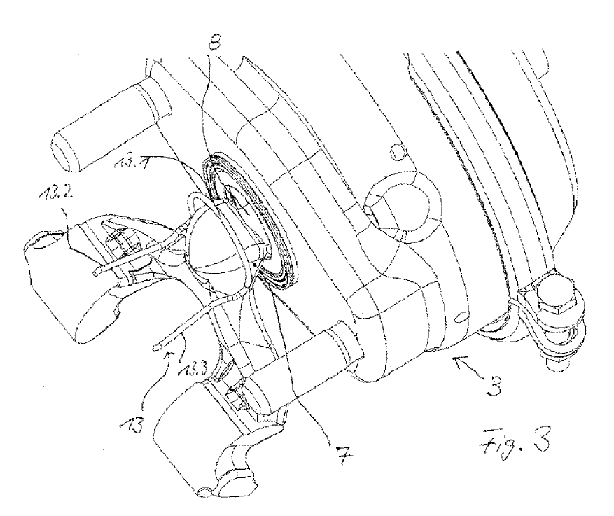

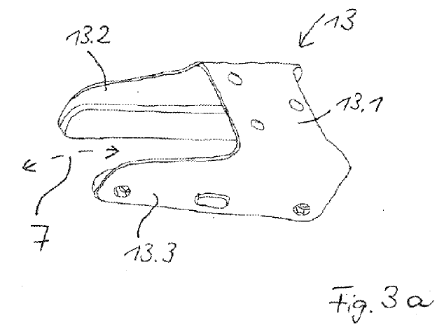

FIGS. 2 and 3 are views of a disc brake based on a first exemplary embodiment of the invention;

FIG. 3a is a perspective view of an alternative to the friction damper of FIGS. 2 and 3; and

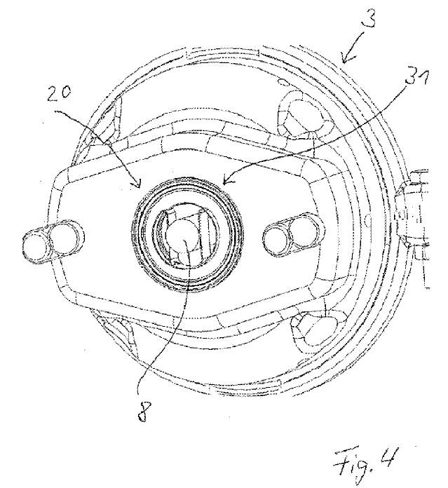

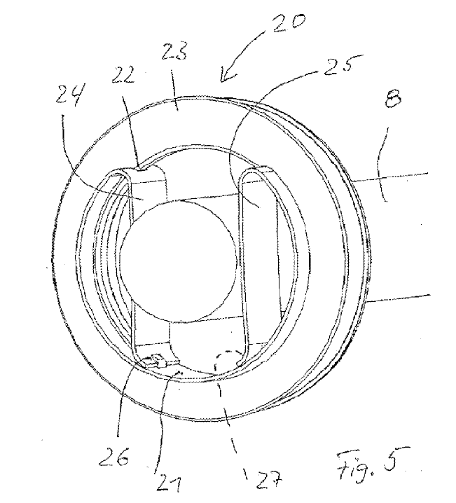

FIGS. 4 and 5 are views of a second embodiment of the invention.

FIG. 1 illustrates a partial section of a brake caliper 1, the two arms of which typically surround or overlap a brake disc 2.

A pneumatic actuation cylinder 3 is attached directly on one end of the caliper. Although FIG. 1 shows a pneumatic actuation cylinder/service brake cylinder of the diaphragm-cylinder type, the invention is also applicable to other cylinder types, such as, for example, to piston cylinders and to spring-loaded cylinders that are also actuated pneumatically. This is also true in regard to the attachment of actuation cylinder 3 to brake caliper 1. Actuation cylinder 3 can in fact also be attached indirectly, that is, for example, at a certain distance from brake caliper 1. However, the actuation cylinder is also always operatively linked together with its actuation device to the brake-application device of the brake.

A brake pad 4 that is movable within the brake is also shown. In addition, the brake disc plane E and brake disc axis A are also illustrated.

A brake-application device generally identified by reference number 6 is disposed on the right side in FIG. 1. Also part of brake-application device 6 is essentially a camshaft 6 that extends parallel to brake disc plane E in brake caliper 1 and is roughly pivotable about rotational axis B, the camshaft being provided with a rotating lever 7 that is swivelable towards brake disc plane E. The end of rotating lever 7 is operatively linked to actuation device 8 in the form of a piston rod of actuation cylinder 3.

When compressed air is applied to actuation cylinder 3, actuation device 8 moves along a longitudinal axis C against a pretension force of a retracting spring 10 mounted between a brake piston 9 and the housing of actuation cylinder 3, thereby moving rotating lever 7 in the direction of the arrow on its rest position (situated at right) to the actuating position situated at left (indicated by the broken line), specifically along a circular-sector-shaped path.

Due to the eccentric structure of the simultaneously-rotating camshaft 6 that rests on brake caliper 1, a displacement of brake pad 4 is effected against brake disc 2, thereby causing braking to occur. Depending on the implementation of the inner brake assembly, additional force-transmitting parts can be connected between camshaft 6 and brake pad 4, such as, for example—and as known from prior art—one or more screws, either individually or in combination with a sliding part known as a bridge/cross member/pressure piece. FIG. 1 thus shows by way of example a sliding part 11 and a pressure screw device 12.

FIG. 1a in principle illustrates the same view as FIG. 1. In addition, however, those pairs of components or assemblies identified schematically by letters a through i are interlinked, between which pairs the frictional connection according to the invention for the purpose of damping can be implemented. The letters here correspond to those letters already used in the introduction to the description.

FIGS. 2 and 3 illustrate an embodiment of the invention comprising friction pairing d (brake caliper 1—rotating lever 7). Very good results are achieved with this embodiment.

A friction damper 13 provided following this has a spring wire that on one side is elastically engaged in a curved section 13.1 running approximately above rotating lever 7 and around this lever, for example, in a retaining groove of brake caliper 1. On the other side, two spring legs 13.2 and 13.3 extend from its curved section 13.1 into the interior of brake caliper 1. They rest by both ends elastically on rotating lever 7. The path and shaping of spring legs 13.1 and 13.2 are dimensioned in terms of the corresponding contact surfaces with rotating lever 7 such that rotating lever 7 can be damped as a function of position by means of friction through varying spring forces.

What is helpful and also provides uniformity in the spring force both when rotating lever 7 is at rest and also when moving past, both spring legs 13.2 and 13.3 can be routed and/or supported on the interior of brake caliper 1. This also improves the reliability of positioning for spring legs 13.2 and 13.3. Another not insignificant aspect is a high axial stiffness for friction damper 13 to enable uniform spring forces to be exerted. It is also possible to use materials other than spring wire.

FIG. 3a illustrates a variant of friction damper 13 in FIG. 3. Since the functional principle is essentially the same, the same corresponding reference numbers are used. One difference consists, however, in the selection of materials. In the friction damper 13 of FIG. 3a, spring components composed of sheet metal are used that have a coating of a material along which rotating lever 7 can move frictionally.

As is evident in a combined views of FIGS. 1 through 3, rotating lever 7 is elastically damped at all positions. Even in the case of torsion, friction damper 13 exerts friction on rotating lever 7. If the excitations of vibrations described in the introduction now occur, whether in the rest position or during braking, vibration of rotating lever 7 can be effectively damped, if not eliminated, by the frictional force applied by friction damper 13. Consequently, no excitation of vibration in actuation device 8 of actuation cylinder 3 and of piston 9 takes place, as well as of retracting spring 10 of actuation cylinder 3, the actuation device being operatively linked to rotating lever 7.

The fundamental principle thus consists in applying a pretensioning force perpendicular to the direction of motion to at least one moving part through, for example, elastic spring legs such that the blows/pulses generated between the brake pad and the rotating brake disc are effectively damped by friction. As a result, any transfer of vibration, or excitation of other components situated within the brake-application flow, are prevented. Any vibrations emanating from these other components or assemblies are also damped.

In the embodiment of FIGS. 2 and 3, the normal force of the frictional connection between friction damper 13 and rotating lever 7 is oriented approximately horizontal. In other words, spring legs 13.2 and 13.3 are oriented approximately laterally relative to the component to be damped, specifically rotating lever 7. As a result, neither the mass/weight of friction damper 13 or of rotating lever 7 acts on the pretensioning force by which friction damper 13 is applied to rotating lever 7.

FIGS. 4 and 5 illustrate another embodiment of the invention.

FIG. 4 here shows one subsection of actuation cylinder 3 as viewed in the direction of opening 31 in the cylinder housing through which actuation device 8 (piston rod) extends. As in FIG. 1, actuation device 8 contacts the head of rotating lever 7.

A friction damper 20 is disposed in opening 31. This corresponds to example g in FIG. 1a. FIG. 5 provides, among other things, an enlarged view of friction damper 20 together with actuation device 8.

Part of friction damper 20 is a ribbon-shaped and non-closed spring ring 21 that has longitudinal slots 22. These slots engage a retaining part to provide rotational and axial locking. The retaining part can be composed of opening 31 of actuation cylinder 3. Alternatively, an intermediate part 23 attached within opening 31 can function as the retaining part.

Two spring legs 24, 25 extend inwards from the open region of spring ring 21, spring legs each having a notch 26, 27 at their lower ends. The notches function to secure the positions of spring legs 24, 25. Either opening 31 or intermediate part 23 can serve this function.

The two spring legs 24, 25 are disposed and designed with such a spring pretension that they contact intermediary actuation device 8. In this embodiment as well, a retaining moment or moment of friction is generated by the elastic retracting force of spring legs 24, 25 due to a pretension, which moment functions to act perpendicular to the direction of motion and to damp undesired vibrations.

In regard to the position and design of spring legs 24, 25 relative to actuation device 8 and axis A, reference is made to a combined view of FIGS. 4 and 5 along with FIG. 1. Depending on the means of interconnection between rotating lever 7 and actuation device 8, actuation device 8 can move linearly relative to rotating lever 7 and spring legs 24, 25 during braking. As FIG. 1 shows, however, rotating lever 7 in the embodiment illustrated moves along a roughly circular-sector-shaped path, a motion that actuation device 8 completes simultaneously. As a result, the two spring legs 24, 25 engage actuation device 8 laterally relative to this path of motion so as to exert a uniform spring pretension in terms of friction damping.

It is of course obvious that other spring shapes are possible as long as they function to effect friction damping.

The features of the invention disclosed in the above description, in the claims, and in the drawing can be essential both individually and in any desired combinations to the implementation of the invention in its various embodiments.

1. Disc brake, in particular, for commercial vehicles, comprising
a disc brake,
a brake caliper,
a brake caliper
a pneumatically operating actuation cylinder that has an actuation device,
a brake-application device that has a rotating lever and a camshaft extending parallel to a brake disc plane, and
at least one brake pad,
wherein the actuation device presses the brake pad against the brake disc by means of the rotating lever and the camshaft when the actuation cylinder is operated,
characterized by
a damping device operating by friction and situated outside the force flow when the brake is applied, the damping device functioning to modify the vibration behavior of the brake.

2. Disc brake, in particular, for commercial vehicles, comprising
a brake disc,
a brake caliper,
a pneumatically operating actuation cylinder that has an actuation device,
a brake-application device that has a rotating lever and a camshaft extending parallel to a brake disc plane, and
at least one brake pad,
wherein the actuation device presses the brake pad by means of the rotating lever and the camshaft against the brake disc when the actuation cylinder is operated,
characterized by
a damping device operating by friction and situated outside the force flow when the brake is applied, the damping device functioning to modify the vibration behavior of the brake, and the damping device operating by an indirect frictional connection between two components or assemblies of the brake that are moved relative to each other when the brake is applied.

3. Disc brake according to claim 1, characterized in that the damping device operates by an indirect or direct frictional connection between two components or assemblies of the brake that are moved relative to each other when the brake is applied.

4. Disc brake according to claim 1, characterized in that the damping device creates an indirect or direction frictional connection between one or more of the following pairs of components or assemblies:
a) brake caliper pressure screw,
(b) brake caliper axially movable pressure piece or cross member,
c) brake caliper camshaft,
d) brake caliper rotating lever,
e) brake caliper actuation device,
f) actuation cylinder rotating lever,
g) actuation cylinder actuation device,
h) actuation cylinder retracting spring, and
i) camshaft pressure piece or cross member.

5. Disc brake according to claim 1, characterized in that the damping device has an elastic device that is pretensioned, and the elastic retracting force of which acts as the normal force of the frictional connection.

6. Disc brake according to claim 1, characterized in that the damping device has a spring.

7. Disc brake according to claim 1, characterized in that the damping device has metal, rubber, plastic, or a combination thereof.

8. Disc brake according to claim 1, characterized in that the damping device (13, 20) has a wire-shaped and/or a ribbon-shaped component.

9. Disc brake according to claim 1, characterized in that the damping device has a coating.

10. Disc brake according to claim 1, characterized in that the region of the frictional connection is situated in the path of the relative motion between the two frictional components or assemblies.

11. Disc brake according to claim 1, characterized in that in the installed state the direction of the normal force of the frictional connection of the damping device encompasses an angle of at maximum 45°, preferably, at maximum 30°, with the horizontal.

12. Actuation cylinder for a disc brake according to claim 1.

13. Actuation cylinder for a disc brake, in particular, according to claim 1, comprising a damping device that creates an indirect or direct frictional connection between the actuation cylinder and
a rotating lever,
an actuation device, and/or
a retracting spring.
